(19) United States
(12) Patent Application Publication
(10) Pub. No.: US 2021/0114468 A1
(43) Pub. Date: Apr. 22, 2021

(54) DATA RECORDING APPARATUS AND DATA RECORDING METHOD

(71) Applicant: TOYOTA JIDOSHA KABUSHIKI KAISHA, Toyota-shi (JP)

(72) Inventors: Ryosuke OYA, Toyota-shi (JP); Keiji KISHIDA, Toyoake-shi (JP)

(21) Appl. No.: 17/027,886

(22) Filed: Sep. 22, 2020

(30) Foreign Application Priority Data
Oct. 17, 2019 (JP) 2019-190149

(51) Int. Cl. B60L 50/60; H01M 10/42; B60W 20/11; G06N 20/00

(52) U.S. Cl. CPC B60L 50/60; H01M 10/425; H01M 2010/4271; G06N 20/00; B60W 20/11

(57) ABSTRACT

The data recording apparatus includes a model storage configured to store a model generated by use of sample data indicating a measurement value of a sample and a degree of deterioration of the sample at the time when the measurement value is obtained, and a controller configured to acquire target data indicating a measurement value of a target and a degree of deterioration of the target at the time when the measurement value is obtained. The model storage stores a first model generated by use of the sample data relevant to the degree of deterioration of the sample belonging to a first range, and a second model generated by use of the sample data relevant to the degree of deterioration of the sample belonging to a second range partially overlapping with the first range. The controller generates first data indicating change in a first abnormality of the target in accordance with the degree of deterioration in the first range, by use of the target data and the first model, and generates second data indicating change in a second abnormality of the target in accordance with the degree of deterioration in the second range, by use of the target data and the second model.

### CROSS REFERENCE TO RELATED APPLICATIONS

The present application claims the priority based on Japanese Patent Application No. 2019-190149 filed on Oct. 17, 2019, the disclosure of which is hereby incorporated by reference in its entirety.

### BACKGROUND

### Field

The present disclosure relates to a data recording apparatus and a data recording method.

### Related Art

JP2015-026252A discloses an apparatus configured to detect abnormality in a vehicle on the basis of a degree of deviation between data acquired from a vehicle and a learning model.

Patent Literature 1: JP2015-026252A

When diagnosing abnormality of a target by use of the apparatus described above, an operator hardly discriminates whether the deviation between the acquired data and the learning model is caused by the abnormality or by normal aged deterioration.

### SUMMARY

In one aspect of the present disclosure, a data recording apparatus is provided. The data recording apparatus includes a model storage configured to store a model generated by use of sample data indicating a sample measurement value obtained by measuring a sample and a degree of deterioration of the sample at the time when the sample measurement value is obtained, a controller configured to acquire target data indicating a target measurement value obtained by measuring a target and a degree of deterioration of the target at the time when the target measurement value is obtained, and configured to generate abnormality data indicating change in a degree of abnormality of the target in accordance with the degree of deterioration, by use of the model and the target data. The model storage stores a first model generated by use of the sample data relevant to the degree of deterioration of the sample belonging to a first range, and a second model generated by use of the sample data relevant to the degree of deterioration of the sample belonging to a second range partially overlapping with the first range. The controller generates first abnormality data indicating change in a first abnormality of the target in accordance with the degree of deterioration in the first range, by using the target data relevant to the degree of deterioration of the target belonging to the first range, and the first model, and generates second abnormality data indicating change in a second abnormality of the target in accordance with the degree of deterioration in the second range, by using the target data relevant to the degree of deterioration of the target belonging to the second range, and the second model.

### BRIEF DESCRIPTION OF THE DRAWINGS

FIG. 1 is an explanatory drawing illustrating a schematic configuration of an abnormality diagnostic system in a first embodiment;

FIG. 2 is an explanatory drawing illustrating a schematic configuration of a data recording apparatus in the first embodiment;

FIG. 3 is an explanatory drawing indicating one example of current voltage characteristics of a fuel cell;

FIG. 4 is an explanatory drawing indicating one example of aged deterioration of the fuel cell;

FIG. 5 is an explanatory drawing indicating one example of change in a degree of abnormality of the fuel cell;

FIG. 6 is a flowchart indicating contents of learning processing in the first embodiment;

FIG. 7 is an explanatory drawing illustrating a model generated in the learning processing in the first embodiment;

FIG. 8 is a flowchart indicating contents of abnormality diagnostic processing in the first embodiment;

FIG. 9 is an explanatory drawing indicating one example of abnormality data in the first embodiment; and

FIG. 10 is an explanatory drawing indicating one example of abnormality data in a comparative example.

### DETAILED DESCRIPTION

### A. First Embodiment

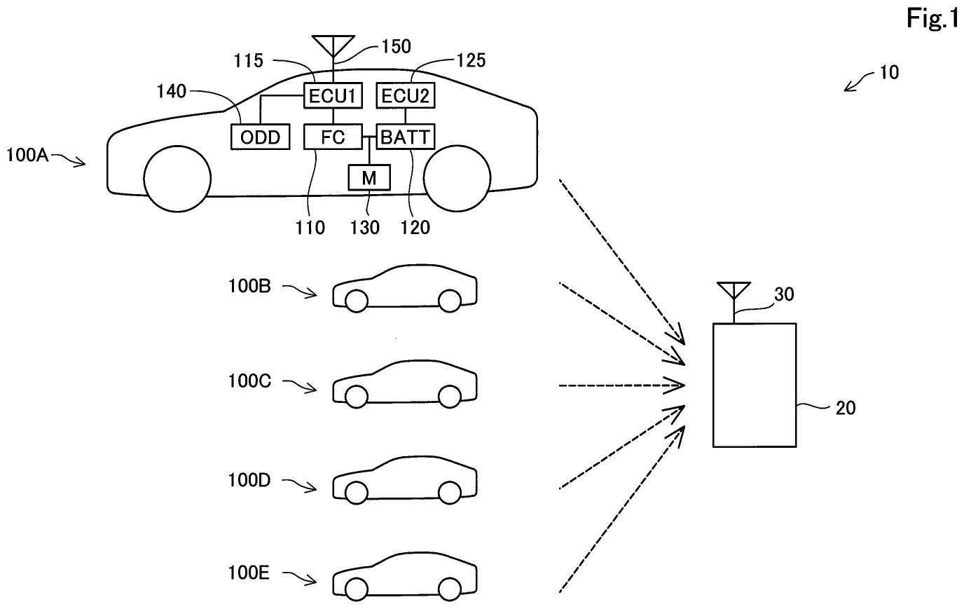

FIG. 1 is an explanatory drawing illustrating a schematic configuration of an abnormality diagnostic system 10 in the first embodiment. The abnormality diagnostic system 10 includes a data recording apparatus 20 and a plurality of fuel cell vehicles 100A to 100E. FIG. 1 shows, as one example, the abnormality diagnostic system 10 including the five fuel cell vehicles 100A to 100E. The fuel cell vehicles 100A to 100E have the same configuration. The characters of “A” to “E” attached to the ends of the codes of the respective fuel cell vehicles 100A to 100E allow to individually identify the fuel cell vehicles 100A to 100E. In the following description, the components belonging to the fuel cell vehicles 100A to 100E respectively have the identical characters of “A” to “E” to individually identify the fuel cell vehicles 100A to 100E. In the case where the fuel cell vehicles 100A to 100E are generally described without particular distinction, the fuel cell vehicle 100 is used without any of the trailing characters of “A” to “E”. In the case where a component is generally described without particular distinction of belonging, the component is described without any of the trailing characters of “A” to “E”. It is noted that the abnormality diagnostic system 10 may include several thousands or tens of thousands of the fuel cell vehicles 100. The abnormality diagnostic system 10 shall include a larger number of the fuel cell vehicles 100. The abnormality diagnostic system 10 shall include the fuel cell vehicles 100 of the same model.

The fuel cell vehicle 100 includes a fuel cell 110, a secondary battery 120, a motor generator 130, an odometer 140, a transmitter 150, a first control unit 115, and a second control unit 125. In the present embodiment, the motor generator 130 rotates drive wheels, whereby the fuel cell vehicle 100 travels. The motor generator 130 is driven by the power supplied by at least one of the fuel cell 110 and the secondary battery 120. The power supply from the fuel cell 110 to the motor generator 130 is controlled by the first control unit 115. The first control unit 115 determines a command value of the output current of the fuel cell 110 in accordance with accelerator opening or the like and makes an auxiliary machine drive according to the command value, thereby controlling the flow rate and pressure of the hydrogen gas to be supplied to the fuel cell 110, the flow rate and pressure of the air to be supplied to the fuel cell 110, and the temperature of the refrigerant to be supplied to the fuel cell 110. The power supply from the secondary battery 120 to the motor generator 130 is controlled by the second control unit 125. The odometer 140 counts and stores an integrated travel distance of the fuel cell vehicle 100. The integrated travel distance means the distance by which the fuel cell vehicle 100 has traveled since its shipment. In the following description, the integrated travel distance is simply referred to as a travel distance. It is noted that the fuel cell vehicle 100 may not include the secondary battery 120 or the second control unit 125.

The transmitter 150 transmits, to the data recording apparatus 20 by wireless communication, the vehicle data indicating a measurement value relevant to the fuel cell 110 mounted on the fuel cell vehicle 100 and the degree of deterioration of the fuel cell 110 at the time when the measurement value is obtained. The term of a measurement value is used as not only a value measured by each of various types of sensors provided on the fuel cell vehicle 100, but also a value calculated by the first control unit 115, the second control unit 125 or the like. In general, as the fuel cell vehicle 100 travels longer, the fuel cell 110 mounted on the fuel cell vehicle 100 is deteriorated more. In the present embodiment, the travel distance of the fuel cell vehicle 100 equipped with the fuel cell 110 is used as the index of the degree of deterioration of the fuel cell 110. In the present embodiment, the vehicle data indicates the information relevant to the identification number of the fuel cell vehicle 100, the information relevant to the travel distance of the fuel cell vehicle 100 acquired from the odometer 140, the command value of the output current of the fuel cell 110 acquired from the first control unit 115, the flow rate, pressure and temperature of the hydrogen gas supplied to the fuel cell 110 and measured by various types of sensors provided in the fuel cell vehicle 100, the flow rate, pressure and temperature of the air supplied to the fuel cell 110, the flow rate, pressure and temperature of the refrigerant supplied to the fuel cell 110, and the information relevant to the output voltage of the fuel cell 110.

A receiver 30 is connected to the data recording apparatus 20. The data recording apparatus 20 records data for diagnosing abnormality of the fuel cells 110A to 110E respectively mounted on the fuel cell vehicles 100A to 100E by use of a plurality of pieces of the vehicle data of the fuel cell vehicles 100A to 100E received by the receiver 30. The data recording apparatus 20 includes a controller 25, and a storage 50. The controller 25 is configured as a computer equipped with a CPU, a memory, and an interface circuit to which respective components are connected. The CPU executes control programs stored in the memory, thereby executing the learning processing and the abnormality diagnostic processing to be described below. It is noted that the data recording apparatus 20 may be configured of the combination of a plurality of computers.

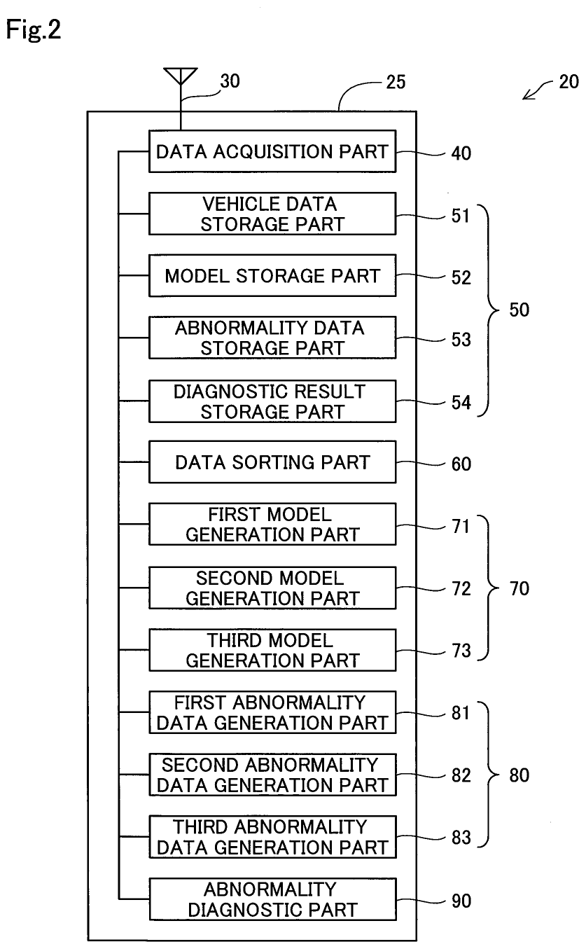

FIG. 2 is an explanatory drawing illustrating the schematic configuration of the data recording apparatus 20. In the present embodiment, the controller 25 includes a data acquisition part 40, a data sorting part 60, a model generation part 70, an abnormality data generation part 80, and an abnormality diagnostic part 90. The storage 50 includes a vehicle data storage part 51, a model storage part 52, an abnormality data storage part 53, and a diagnostic result storage part 54. The model generation part 70 includes a first model generation part 71, a second model generation part 72, and a third model generation part 73. The abnormality data generation part 80 includes a first abnormality data generation part 81, a second abnormality data generation part 82, and a third abnormality data generation part 83.

The data acquisition part 40 acquires the vehicle data received by the receiver 30. The data acquisition part 40 transmits the acquired vehicle data to the vehicle data storage part 51. The vehicle data storage part 51 stores the vehicle data transmitted by the data acquisition part 40.

In the learning processing, the data sorting part 60 reads the vehicle data stored in the vehicle data storage part 51, and transmits the read vehicle data to the first model generation part 71, the second model generation part 72 and the third model generation part 73 on the basis of predetermined conditions. In the abnormality diagnostic processing, the data sorting part 60 reads the vehicle data stored in the vehicle data storage part 51, and transmits the read vehicle data to the first abnormality data generation part 81, the second abnormality data generation part 82 and the third abnormality data generation part 83 on the basis of predetermined conditions. In the present embodiment, in the learning processing, the data sorting part 60 transmits the read vehicle data to the first model generation part 71, the second model generation part 72 and the third model generation part 73, on the basis of the conditions related to the travel distances of the fuel cell vehicle 100 indicated in the vehicle data. In the abnormality diagnostic processing, the data sorting part 60 transmits the read vehicle data to the first abnormality data generation part 81, the second abnormality data generation part 82 and the third abnormality data generation part 83, on the basis of the same conditions as the conditions used in the learning processing.

In the learning processing, the model generation part 70 generates a model for calculating a prediction value relevant to the fuel cell 110, by using the vehicle data. In the present embodiment, the model generation parts 71 to 73 of the model generation part 70 respectively generate models for calculating prediction values relevant to the fuel cell 110. The first model generation part 71 generates a first model MD1 by using the vehicle data transmitted by the data sorting part 60. The second model generation part 72 generates a second model MD2 by using the vehicle data transmitted by the data sorting part 60. The third model generation part 73 generates a third model MD3 by using the vehicle data transmitted by the data sorting part 60. The model generation parts 71 to 73 respectively transmit the generated models MD1 to MD3 to the model storage part 52. The model storage part 52 stores the models MD1 to MD3 respectively transmitted by the model generation parts 71 to 73. It is noted that the vehicle data for use in the generation of the models MD1 to MD3 may be referred to as sample data, and that the fuel cell 110 relevant to the sample data may be referred to as a sample.

In the abnormality diagnostic processing, the abnormality data generation part 80 generates abnormality data indicating change in the degree of abnormality of the fuel cell 110 in accordance with the degree of deterioration, by using the models MD1 to MD3 and the vehicle data. In the present embodiment, the abnormality data generation parts 81 to 83 of the abnormality data generation part 80 respectively generate the abnormality data indicating change in the degree of abnormality of the fuel cell 110 in accordance with the travel distances of the fuel cell vehicle 100. The first abnormality data generation part 81 generates first abnormality data, by using the vehicle data transmitted by the data sorting part 60 and the first model MD1 stored in the model storage part 52. The second abnormality data generation part 82 generates second abnormality data, by using the vehicle data transmitted by the data sorting part 60 and the second model MD2 stored in the model storage part 52. The third abnormality data generation part 83 generates third abnormality data, by using the vehicle data transmitted by the data sorting part 60 and the third model MD3 stored in the model storage part 52. The abnormality data generation parts 81 to 83 respectively transmit the generated abnormality data to the abnormality data storage part 53. The abnormality data storage part 53 stores the abnormality data transmitted by the abnormality data generation parts 81 to 83, respectively. It is noted that the vehicle data for use in the generation of the abnormality data may be referred to as target data, and that the fuel cell 110 related to the target data may be referred to as a target.

In the abnormality diagnostic processing, the abnormality diagnostic part 90 diagnoses abnormality of the fuel cell 110, by using the abnormality data stored in the abnormality data storage part 53. The abnormality diagnostic part 90 transmits information relevant to the diagnostic result to the diagnostic result storage part 54. The diagnostic result storage part 54 stores the information relevant to the diagnostic result.

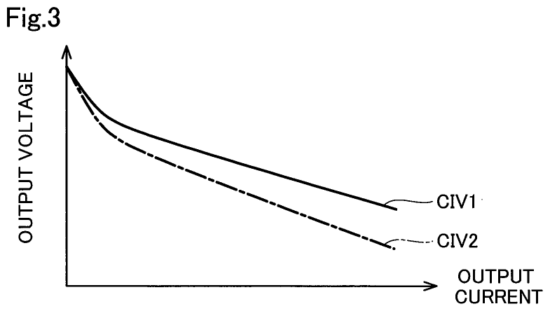

FIG. 3 is an explanatory drawing indicating one example of the current voltage characteristics of the fuel cell 110. In the following description, the current voltage characteristics are referred to as IV characteristics. The horizontal axis represents output current of the fuel cell 110. The vertical axis represents output voltage of the fuel cell 110. In FIG. 3, a first curve CIV1 denoted by the solid line represents the IV characteristics of the fuel cell 110 at the time of the shipment of the fuel cell vehicle 100, while a second curve CIV2 denoted by the one-dot chain line represents the IV characteristics of the fuel cell 110 with aged deterioration. As shown in FIG. 3, the output voltage of the fuel cell 110 is decreased due to the aged deterioration.

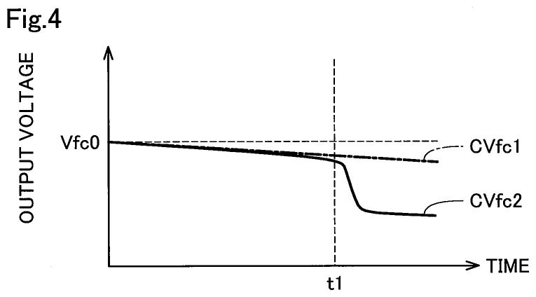

FIG. 4 is an explanatory drawing indicating one example of transition of the deterioration of the fuel cell 110. The horizontal axis represents time. The vertical axis represents output voltage of the fuel cell 110. In FIG. 4, each of a first curve CVfc1 and a second curve CVfc2 represents the transition of the output voltage of the fuel cell 110, of the case where the command value of the output current of the fuel cell 110 is kept constant. In general, as indicated by the first curve CVfc1, the output voltage of the fuel cell 110 is gradually decreased due to the aged deterioration. The gradual decrease of the output voltage due to the aged deterioration or the like is referred to as normal deterioration. Unlike the normal deterioration, in some cases, the output voltage of the fuel cell 110 is decreased rapidly, as indicated by the second curve CVfc2. The rapid decrease of the output voltage is referred to as abnormal deterioration. In the case where such abnormal deterioration occurs, there is a high possibility that unexpected failure has occurred in the fuel cell 110. In the present embodiment, the data recording apparatus 20 is configured to detect the abnormal deterioration of the fuel cell 110.

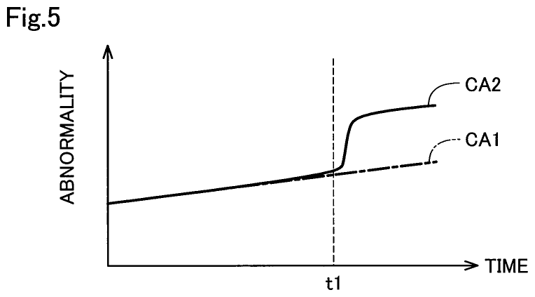

FIG. 5 is an explanatory drawing illustrating one example of change in the degree of abnormality of the fuel cell 110. The horizontal axis represents time. The vertical axis represents degree of abnormality of the fuel cell 110. The degree of abnormality of the fuel cell 110 is represented by the difference between the prediction value of the output voltage and the actual output voltage of the fuel cell 110. In FIG. 5, a first curve CA1 denoted by the one-dot chain line represents transition of the degree of abnormality of the case where the abnormal deterioration has not occurred, while a second curve CA2 denoted by the solid line represents transition of the degree of abnormality of the case where the abnormal deterioration has occurred in the vicinity of a time t1. Since the fuel cell vehicle 100 repeats acceleration and deceleration in general, the output voltage of the fuel cell 110 is not kept constant. Therefore, it is difficult to discriminate between abnormal deterioration and normal deterioration even by analyzing the transition of the output voltage of the fuel cell 110. In the present embodiment, the transition of the degree of abnormality is analyzed, thereby enabling to discriminate between abnormal deterioration and normal deterioration.

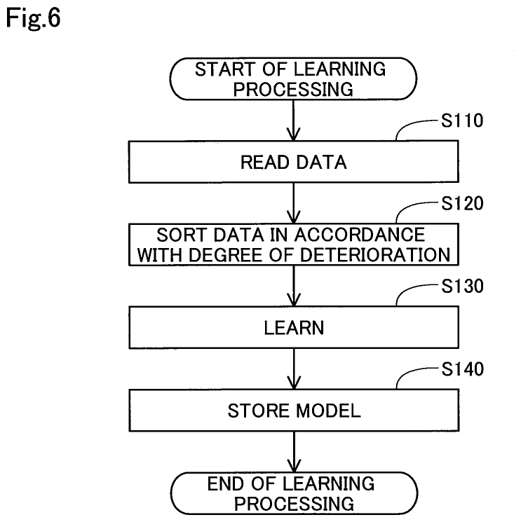

FIG. 6 is a flowchart indicating the contents of the learning processing in the present embodiment. The present processing is executed by the data recording apparatus 20 at predetermined timing. In the present embodiment, the data recording apparatus 20 executes the present processing once a month. The data recording apparatus 20 may execute the present processing at a time when a predetermined number of pieces of the vehicle data are accumulated in the vehicle data storage part 51. First, in step S110, the data sorting part 60 reads the plurality of pieces of vehicle data which have been acquired from the plurality of fuel cell vehicles 100A to 100E and are stored in the vehicle data storage part 51 respectively.

Then, in step S120, the data sorting part 60 transmits the plurality of pieces of read vehicle data respectively to the first model generation part 71, the second model generation part 72 and the third model generation part 73, on the basis of the predetermined conditions. In the present embodiment, the data sorting part 60 includes predetermined conditions of a first condition, a second condition and a third condition. In the first condition, the travel distance indicated in the vehicle data falls within a first range SEC1 between 0 km and 12000 km inclusive. In the second condition, the travel distance indicated in the vehicle data falls within a second range SEC2 between 8000 km and 24000 km inclusive. In the third condition, the travel distance indicated in the vehicle data falls within a third range SEC3 of 20000 km and above. The range between 8000 km and 12000 km inclusive corresponds to a part of the first range SEC1 and also a part of the second range SEC2. The range between 20000 km and 24000 km inclusive corresponds to a part of the second range SEC2 and also a part of the third range SEC3. The length of the travel distance of the overlapping portion of the first range SEC1 and the second range SEC2, and the length of the travel distance of the overlapping portion of the second range SEC2 and the third range SEC3 are set equal to or longer than the travel distance subjected to the analysis of the transition of the degree of abnormality at the time of the discrimination as to whether or not the abnormal deterioration is present. In the present embodiment, since the transition of the degree of abnormality is analyzed in terms of the length of 4000 km for the discrimination as to whether or not the abnormal deterioration is present, the length of 4000 km is set as the length of the travel distance of the overlapping portion of the first range SEC1 and the second range SEC2, and as the length of the travel distance of the overlapping portion of the second range SEC2 and the third range SEC3.

The data sorting part 60 transmits the pieces of vehicle data satisfying the first condition among the plurality of pieces of read vehicle data to the first model generation part 71, transmits the pieces of vehicle data satisfying the second condition to the second model generation part 72, and transmits the pieces of vehicle data satisfying the third condition to the third model generation part 73. The data sorting part 60 transmits the pieces of vehicle data satisfying the first condition and further satisfying the second condition among the plurality of pieces of read vehicle data, to the first model generation part 71 and the second model generation part 72. The data sorting part 60 transmits the pieces of vehicle data satisfying the second condition and further satisfying the third condition among the plurality of pieces of read vehicle data, to the second model generation part 72 and the third model generation part 73. When the vehicle data stored in the vehicle data storage part 51 is classified on the basis of the travel distances indicated in the vehicle data, the number of the pieces of vehicle data relevant to relatively short travel distances is greater than the number of the pieces of vehicle data relevant to relatively long travel distances. Therefore, the number of the pieces of vehicle data transmitted to the first model generation part 71 is greater than the number of the pieces of vehicle data transmitted to the second model generation part 72. The number of the pieces of vehicle data transmitted to the second model generation part 72 is greater than the number of the pieces of vehicle data transmitted to the third model generation part 73.

In step S130, the first model generation part 71 generates the first model MD1 for use in the calculation of the degree of abnormality of the fuel cell 110 in the first range SEC1, by using the vehicle data transmitted by the data sorting part 60. The second model generation part 72 generates the second model MD2 for use in the calculation of the degree of abnormality of the fuel cell 110 in the second range SEC2, by using the vehicle data transmitted by the data sorting part 60. The third model generation part 73 generates the third model MD3 for use in the calculation of the degree of abnormality of the fuel cell 110 in the third range SEC3, by using the vehicle data transmitted by the data sorting part 60.

In the present embodiment, the model generation parts 71 to 73 generate the models MD1 to MD3, respectively, by using machine learning. The type of machine learning may be supervised learning, or may be unsupervised learning. The model generation parts 71 to 73 respectively generate the models MD1 to MD3, by using, for example, a neural network. The vehicle data stored in the vehicle data storage part 51 is highly likely the vehicle data of the fuel cell vehicle 100 without abnormal deterioration. Therefore, in the case of unsupervised learning, the vehicle data stored in the vehicle data storage part 51 may be treated as the vehicle data of the fuel cell vehicle 100 without abnormal deterioration. In the case where the vehicle data during when the abnormal deterioration occurs is identified previously, the model generation parts 71 to 73 may respectively generate the models MD1 to MD3 without using the vehicle data during when the abnormal deterioration occurs. This allows to improve the precision of the generated models MD1 to MD3.

In step S140, the first model generation part 71 stores the generated first model MD1 in the model storage part 52. The second model generation part 72 stores the generated second model MD2 in the model storage part 52. The third model generation part 73 stores the generated third model MD3 in the model storage part 52. Thereafter, the data recording apparatus 20 terminates the present processing. The data recording apparatus 20 re-executes the learning processing one month later. During one month, the vehicle data is further accumulated in the vehicle data storage part 51. Therefore, in the learning processing executed one month later, new models are generated as the first model MD1, the second model MD2 and the third model MD3.

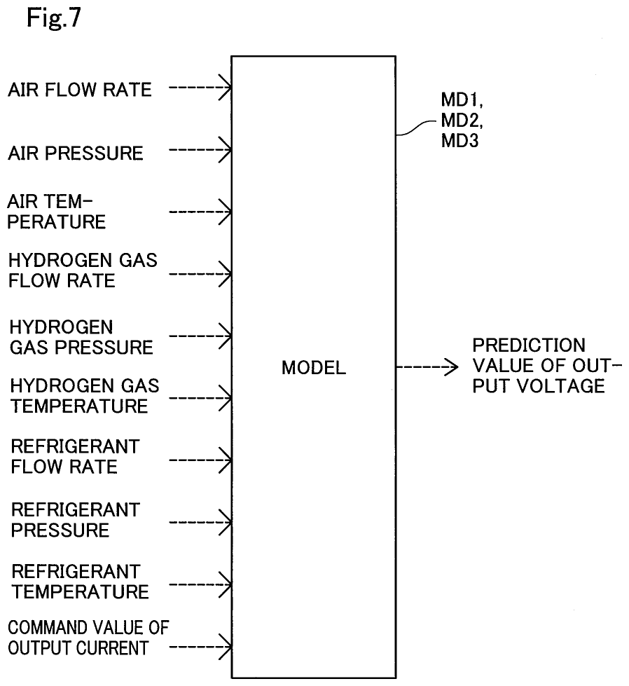

FIG. 7 is an explanatory drawing illustrating each of the models MD1 to MD3 generated in the learning processing in the present embodiment. In the present embodiment, various values indicated in the vehicle data are input into each of the models MD1 to MD3, including a measurement value of a flow rate of air, a measurement value of a pressure of air, a measurement value of a temperature of air, a measurement value of a flow rate of hydrogen gas, a measurement value of a pressure of hydrogen gas, a measurement value of a temperature of hydrogen gas, a measurement value of a flow rate of refrigerant, a measurement value of a pressure of refrigerant, a measurement value of a temperature of refrigerant, and a command value of output current. Each of the models MD1 to MD3 outputs a prediction value of output voltage on the basis of the combination of each of the input measurement values and the input command value of output current. As described above, the first model MD1 is generated by use of the vehicle data relevant to the travel distance indicated therein falling within the first range SEC1; the second model MD2 is generated by use of the vehicle data relevant to the travel distance indicated therein falling within the second range SEC2; and the third model MD3 is generated by use of the vehicle data relevant to the travel distance indicated therein falling within the third range SEC3. Therefore, in the case where the same values are input into the models MD1 to MD3, the values output by the models MD1 to MD3 differ, in accordance with the decreased amounts in the output voltage due to aged deterioration.

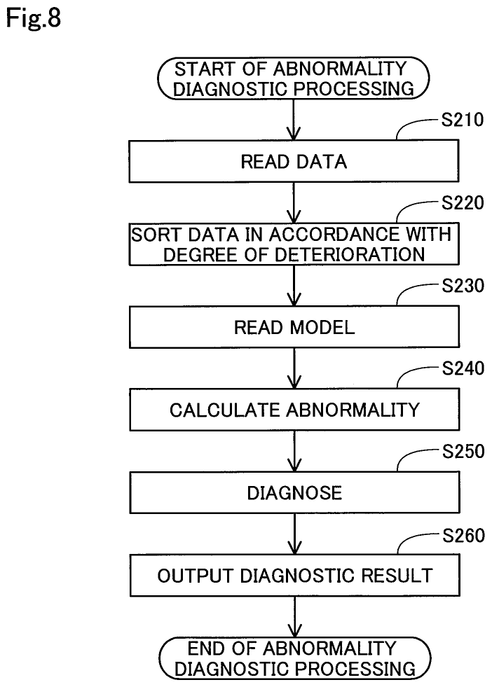

FIG. 8 is a flowchart indicating the contents of the abnormality diagnostic processing in the present embodiment. The present processing is executed by the data recording apparatus 20 at predetermined timing. In an example, the data recording apparatus 20 executes the present processing at a time when a predetermined number of pieces of the vehicle data are accumulated in the vehicle data storage part 51. First, in step S210, the data sorting part 60 reads the plurality of pieces of vehicle data which have been acquired from the plurality of fuel cell vehicles 100A to 100E and are stored in the vehicle data storage part 51.

Then in step S220, the data sorting part 60 transmits the plurality of pieces of vehicle data respectively to the first abnormality data generation part 81, the second abnormality data generation part 82 and the third abnormality data generation part 83, on the basis of the same conditions as the first condition, the second condition and the third condition used in the learning processing. The data sorting part 60 transmits the pieces of vehicle data satisfying the first condition among the plurality of pieces of read vehicle data to the first abnormality data generation part 81, transmits the pieces of vehicle data satisfying the second condition to the second abnormality data generation part 82, and transmits the pieces of vehicle data satisfying the third condition to the third abnormality data generation part 83. The data sorting part 60 transmits the pieces of vehicle data satisfying the first condition and further satisfying the second condition among the plurality of pieces of read vehicle data, to the first abnormality data generation part 81 and the second abnormality data generation part 82. The data sorting part 60 transmits the pieces of vehicle data satisfying the second condition and further satisfying the third condition among the plurality of pieces of read vehicle data, to the second abnormality data generation part 82 and the third abnormality data generation part 83.

In step S230, the first abnormality data generation part 81 reads the first model MD1 from the model storage part 52, and the second abnormality data generation part 82 reads the second model MD2 from the model storage part 52. The third abnormality data generation part 83 reads the third model MD3 from the model storage part 52.

In step S240, the first abnormality data generation part 81 generates the first abnormality data indicating the change in a first abnormality 61 which corresponds to the degree of abnormality in accordance with a travel distance in the first range SEC1, by using the plurality of pieces of vehicle data transmitted by the data sorting part 60 and the first model MD1. Specifically, the first abnormality data generation part 81 first calculates a prediction value of the output voltage of the fuel cell 110A to be measured in the first range SEC1, by using the first model MD1 and the plurality of pieces of vehicle data which relate to the fuel cell vehicle 100A, belong to the first range SEC1, and have been transmitted by the data sorting part 60. In the following description, a prediction value of the output voltage of the fuel cell 110 to be measured in the first range SEC1 is, referred to as a first prediction value. The first abnormality data generation part 81 then calculates the difference between the calculated first prediction value and the measurement value of the output voltage indicated in the vehicle data relevant to the fuel cell vehicle 100A, as the first abnormality 61 of the fuel cell 110A. The first abnormality data generation part 81 calculates the first abnormality 61 of the fuel cell 110A for each travel distance in the first range SEC1, and generates the first abnormality data relevant to the fuel cell 110A. The first abnormality data generation part 81 generates the first abnormality data relevant to each of the other fuel cells 110B to 110E, by executing the processing of the same contents as the processing for the first abnormality data relevant to the fuel cell 110A.

The second abnormality data generation part 82 generates the second abnormality data indicating the change in a second abnormality 62 which corresponds to the degree of abnormality in accordance with a travel distance in the second range SEC2, by using the plurality of pieces of vehicle data transmitted by the data sorting part 60 and the second model MD2. The second abnormality data generation part 82, by executing the processing of the same contents as the processing for the first abnormality data executed by the first abnormality data generation part 81, calculates a second prediction value which is a prediction value of the output voltage of the fuel cell 110 to be measured in the second range SEC2, and calculates the difference between the calculated second prediction value and the measurement value of the output voltage indicated in the vehicle data, as the second abnormality 62. The second abnormality data generation part 82 calculates the second abnormality 62 for each piece of vehicle data belonging to the second range SEC2, and generates the second abnormality data for each of the fuel cells 110A to 110E.

The third abnormality data generation part 83 generates the third abnormality data indicating the change in a third abnormality 63 which corresponds to the degree of abnormality in accordance with a travel distance in the third range SEC3, by using the plurality of pieces of vehicle data transmitted by the data sorting part 60 and the third model MD3. The third abnormality data generation part 83, by executing the processing of the same contents as the processing for the first abnormality data executed by the first abnormality data generation part 81, calculates a third prediction value which is a prediction value of the output voltage of the fuel cell 110 to be measured in the third range SEC3, and calculates the difference between the calculated third prediction value and the measurement value of the output voltage indicated in the vehicle data, as the third abnormality 63. The third abnormality data generation part 83 calculates the third abnormality 63 for each piece of vehicle data belonging to the third range SEC3, and generates the third abnormality data for each of the fuel cells 110A to 110E.

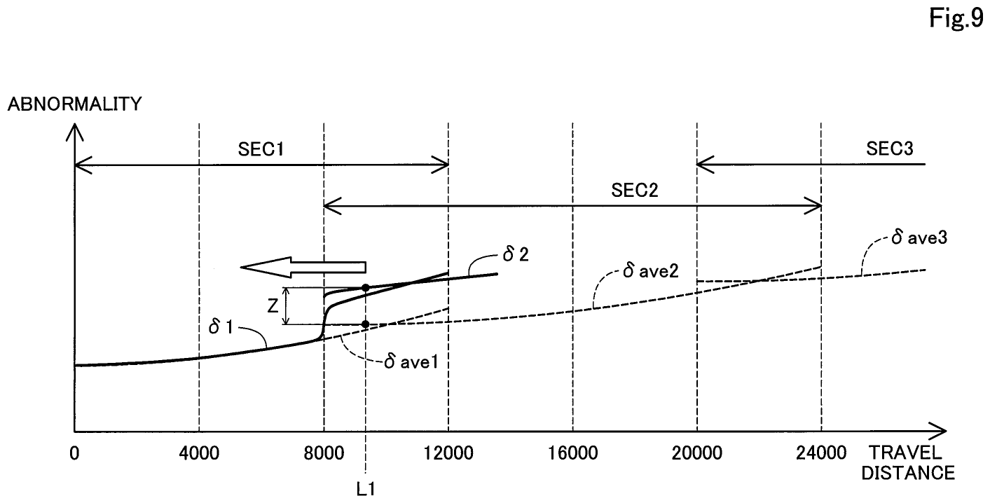

FIG. 9 is an explanatory drawing indicating one example of the abnormality data in the present embodiment. The horizontal axis represents travel distance. The vertical axis represents degree of abnormality. In the present embodiment, the first range SEC1 and the second range SEC2 partially overlap with each other, and the second range SEC2 and the third range SEC3 partially overlap with each other. FIG. 9 shows one example, and the solid line represents change in the first abnormality δ1 and the second abnormality 82 in accordance with a travel distance, relevant to the fuel cell 110 with the abnormal deterioration having occurred in the range of 8000 km to 12000 km.

In step S250, by referring to FIG. 8 and FIG. 9, the abnormality diagnostic part 90 diagnoses the abnormality of the fuel cell 110, by using the plurality of pieces of abnormality data respectively generated by the abnormality data generation parts 81 to 83. The abnormality diagnostic part 90 calculates a first abnormality average value δave1 for each travel distance in the first range SEC1 by using the first abnormality data relevant to all of the fuel cell vehicles 100A to 100E, to calculate a deviation of the first abnormality in the first range SEC1. The abnormality diagnostic part 90 calculates a second abnormality average value δave2 for each travel distance in the second range SEC2 by using the second abnormality data relevant to all of the fuel cell vehicles 100A to 100E, to calculate a deviation of the second abnormality in the second range SEC2. The abnormality diagnostic part 90 calculates a third abnormality average value δave3 for each travel distance in the third range SEC3 by using the third abnormality data relevant to all of the fuel cell vehicles 100A to 100E, to calculate a deviation of the third abnormality in the third range SEC3. Each deviation of the degree of abnormality in the ranges SEC1 to SEC3 may be calculated, by use of each median value of the degree of abnormality in each of the range SEC1 to SEC3, instead of each of the average values δave1 to δave3 of the degree of abnormality in the ranges SEC1 to SEC3. It is noted that a greater number of pieces of the vehicle data relevant to shorter travel distances are accumulated in the vehicle data storage part 51. In some cases, the vehicle data relevant to longer travel distances in terms of just one fuel cell vehicle 100 may be accumulated in the vehicle data storage part 51. In the range where the pieces of vehicle data relevant to just one fuel cell vehicle 100 are accumulated, the obtained deviation of the degree of abnormality becomes zero.

The abnormality diagnostic part 90 extracts the abnormality data relevant to the fuel cell 110 in which the deviation of the first abnormality is equal to or more than a predetermined threshold Z, extracts the abnormality data relevant to the fuel cell 110 in which the deviation of the second abnormality is equal to or more than the threshold Z, and extracts the abnormality data relevant to the fuel cell 110 in which the deviation of the third abnormality is equal to or more than the threshold Z. The abnormality diagnostic part 90 analyzes the extracted pieces of abnormality data relevant to the fuel cell 110, to discriminate whether or not the abnormal deterioration is present, in terms of the travel distance traced back from the time when the deviation of the degree of abnormality reaches the threshold value Z or more.

In the present embodiment, as indicated by the arrow in FIG. 9, the abnormality diagnostic part 90 discriminates whether or not the abnormal deterioration is present, in terms of the travel distance of last 4000 km traced back from a time L1 when the deviation of the degree of abnormality reaches the threshold value Z or more. The abnormality diagnostic part 90 discriminates that the abnormal deterioration is present in the case where the amount of increase in the degree of abnormality at the time when the travel distance is increased by a predetermined distance is equal to or more than a predetermined amount, and discriminates that the abnormal deterioration is absent in the case where the amount of increase in the degree of abnormality at the time when the travel distance is increased by a predetermined distance is less than a predetermined amount. It is noted that, in the case of discriminating whether or not the abnormal deterioration is present by tracing back the travel distance from a point less than 4000 km, the abnormality diagnostic part 90 discriminates whether or not the abnormal deterioration is present by tracing back the travel distance to 0 km.

In the present embodiment, the lengths of the overlapping portions of the respective ranges SEC1 to SEC3 therebetween are equal to the length of the travel distance to be traced back, and the lengths of the non-overlapping portions of the respective ranges SEC1 to SEC3 not overlapping therebetween are longer than the length of the travel distance to be traced back. Thus, there are various cases, including the case of tracing back from a point in the non-overlapping portion of the first range SEC1 to another point in the non-overlapping portion of the first range SEC1, the case of tracing back from a point in the overlapping portion of the first range SEC1 and the second range SEC2 to a point in the non-overlapping portion of the first range SEC1, and the case of tracing back from a point in the non-overlapping portion of the second range SEC2 to a point in the overlapping portion of the first range SEC1 and the second range SEC2, the case of tracing back from a point in the non-overlapping portion of the second range SEC2 to another point in the non-overlapping portion of the second range SEC2, the case of tracing back from a point in the overlapping portion of the second range SEC2 and the third range SEC3 to a point in the non-overlapping portion of the second range SEC2, the case of tracing back from a point in the non-overlapping portion of the third range SEC3 to a point in the overlapping portion of the second range SEC2 and the third range SEC3, and the case of tracing back from a point in the non-overlapping portion of the third range SEC3 to another point in the non-overlapping portion of the third range SEC3.

In the present embodiment, when discriminating whether or not the abnormal deterioration is present by tracing back the travel distance, the abnormality diagnostic part 90 discriminates whether or not the abnormal deterioration is present without switching the abnormality data to be analyzed. In the case of tracing back from a point in the non-overlapping portion of the first range SEC1 to another point in the non-overlapping portion of the first range SEC1, the abnormality diagnostic part 90 discriminates whether or not the abnormal deterioration is present, by analyzing the first abnormality data. In the case of tracing back from a point in the overlapping portion of the first range SEC1 and the second range SEC2 to a point in the non-overlapping portion of the first range SEC1, the abnormality diagnostic part 90 discriminates whether or not the abnormal deterioration is present, by analyzing the first abnormality data. In the case of tracing back from a point in the non-overlapping portion of the second range SEC2 to a point in the overlapping portion of the first range SEC1 and the second range SEC2, the abnormality diagnostic part 90 discriminates whether or not the abnormal deterioration is present, by analyzing the second abnormality data. In the case of tracing back from a point in the non-overlapping portion of the second range SEC2 to another point in the non-overlapping portion of the second range SEC2, the abnormality diagnostic part 90 discriminates whether or not the abnormal deterioration is present, by analyzing the second abnormality data. In the case of tracing back from a point in the overlapping portion of the second range SEC2 and the third range SEC3 to a point in the non-overlapping portion of the second range SEC2, the abnormality diagnostic part 90 discriminates whether or not the abnormal deterioration is present, by analyzing the second abnormality data. In the case of tracing back from a point in the non-overlapping portion of the third range SEC3 to a point in the overlapping portion of the second range SEC2 and the third range SEC3, the abnormality diagnostic part 90 discriminates whether or not the abnormal deterioration is present, by analyzing the third abnormality data. In the case of tracing back from a point in the non-overlapping portion of the third range SEC3 to another point in the non-overlapping portion of the third range SEC3, the abnormality diagnostic part 90 discriminates whether or not the abnormal deterioration is present, by analyzing the third abnormality data. It is noted that, in the case where the lengths of the non-overlapping portions of the respective ranges SEC1 to SEC3 are set equal to or shorter than the length of the travel distance to be traced back, the travel distance may be traced back from a point in the overlapping portion of the second range SEC2 and the third range SEC3 to a point in the overlapping portion of the first range SEC1 and the second range SEC2. In the case of tracing back from a point in the overlapping portion of the second range SEC2 and the third range SEC3 to a point in the overlapping portion of the first range SEC1 and the second range SEC2, the abnormality diagnostic part 90 discriminates whether or not the abnormal deterioration is present, by analyzing the second abnormality data.

In step S260, the abnormality diagnostic part 90 stores the identification number of the fuel cell vehicle 100, and the diagnostic result indicating the presence or absence of the abnormal deterioration in the fuel cell 110 mounted on the fuel cell vehicle 100, in the diagnostic result storage part 54. The data recording apparatus 20 thereafter terminates the present processing. The data recording apparatus 20 re-executes the present processing at a time when a predetermined number of pieces of the vehicle data are further accumulated in the vehicle data storage part 51.

In the abnormality diagnostic system 10 of the present embodiment described above, the data recording apparatus 20 generates and records the plurality of pieces of abnormality data indicating change in the respective abnormalities 81 to 83 in accordance with the degree of deterioration in the respective ranges SEC1 to SEC3. In particular, in the present embodiment, the data recording apparatus 20 is capable of generating and storing the plurality of pieces of abnormality data indicating change in the respective abnormalities 81 to 83 in accordance with the degree of deterioration of the fuel cell 110 mounted on the fuel cell vehicle 100. In the present embodiment, the travel distance of the fuel cell vehicle 100 is used as the index indicating the degree of deterioration of the fuel cell 110. Thus, the plurality of pieces of abnormality data are generated, respectively indicating change in the respective abnormalities 81 to 83 in accordance with the travel distance. As shown in FIG. 9, the lengths of the overlapping portions of the respective ranges SEC1 to SEC3 overlapping therebetween are set equal to the length of the travel distance to be traced back for analysis, and the lengths of the non-overlapping portions of the respective ranges SEC1 to SEC3 not overlapping therebetween are set longer than the length of the travel distance to be traced back for analysis. Therefore, in the case of extracting the respective pieces of abnormality data from the data recording apparatus 20 for diagnosing of the fuel cell 110 as to whether or not the abnormal deterioration is present, an operator is able to, by using the first abnormality data, analyze change in the first abnormality 61 by tracing back the travel distance from a point in the non-overlapping portion of the first range SEC1 to another point in the non-overlapping portion of the first range SEC1, and analyze change in the first abnormality 61 by tracing back the travel distance from a point in the overlapping portion of the first range SEC1 and the second range SEC2 to a point in the non-overlapping portion of the first range SEC1. An operator is able to, by using the second abnormality data, analyze change in the second abnormality 62 by tracing back the travel distance from a point in the non-overlapping portion of the second range SEC2 to a point in the overlapping portion of the first range SEC1 and the second range SEC2, analyze change in the second abnormality 62 by tracing back the travel distance from a point in the non-overlapping portion of the second range SEC2 to another point in the non-overlapping portion of the second range SEC2, and analyze change in the second abnormality 62 by tracing back the travel distance from a point in the overlapping portion of the second range SEC2 and the third range SEC3 to a point in the non-overlapping portion of the second range SEC2. An operator is able to, by using the third abnormality data, analyze change in the third abnormality 63 by tracing back the travel distance from a point in the non-overlapping portion of the third range SEC3 to a point in the overlapping portion of the second range SEC2 and the third range SEC3, and analyze change in the third abnormality 63 by tracing back the travel distance from a point in the non-overlapping portion of the third range SEC3 to another point in the non-overlapping portion of the third range SEC3. Accordingly, when diagnosing the fuel cell 110 mounted on the fuel cell vehicle 100 as to whether or not the abnormal deterioration is present, the operator is able to perform appropriate diagnosis by discriminating between abnormal deterioration and normal aged deterioration of the fuel cell 110. In the present embodiment, the abnormality diagnostic part 90, in place of an operator, executes the above-described analysis of change in the respective abnormalities 81 to 83. Thus, the abnormality diagnostic part 90 is capable of automatically diagnosing the fuel cell 110 as to whether or not the abnormal deterioration is present, without operator's analysis of change in the respective abnormalities 81 to 83.

In the present embodiment, the data recording apparatus 20 calculates a prediction value of the output voltage by taking into consideration the degree of deterioration of the fuel cell 110 in the respective ranges SEC1 to SEC3, on the basis of the models MD1 to MD3 respectively generated by use of the vehicle data belonging to the ranges SEC1 to SEC3. Thus, the data recording apparatus 20 is capable of calculating the respective abnormalities 81 to 83 in accordance with the degree of deterioration of the fuel cell 110 without using the degree of deterioration of the fuel cell 110 for the input to the models MD1 to MD3, thereby enabling to reduce a calculation load on the data recording apparatus 20.

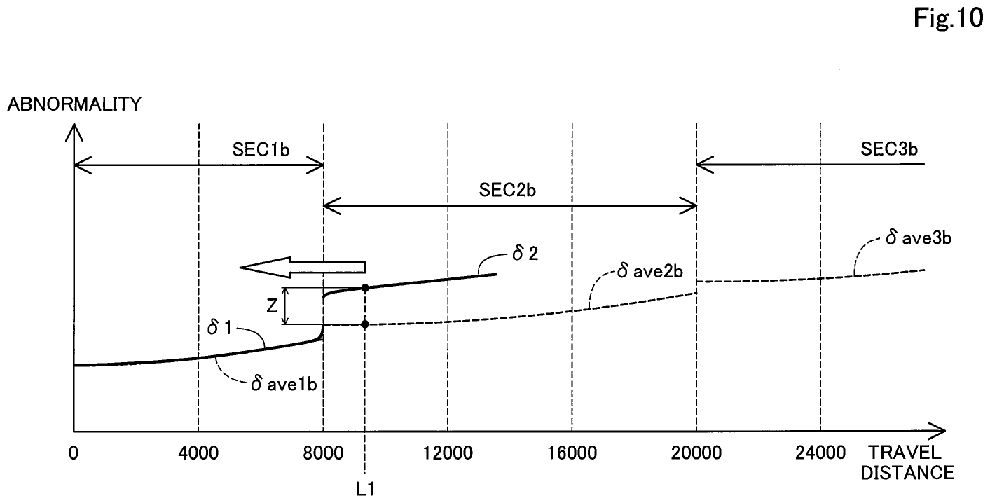

In the present embodiment, the data recording apparatus 20 includes the abnormality diagnostic part 90. In the case of diagnosis of abnormality by tracing back from a point in the non-overlapping portion of the second range SEC2 exceeding the first range SEC1 toward the overlapping portion of the second range SEC2 overlapping with the first range SEC1, the abnormality diagnostic part 90 discriminates whether or not the abnormal deterioration is present by using the second abnormality data without switching the abnormality data to be analyzed from the second abnormality data to the first abnormality data, even beyond the boundary between the non-overlapping portion and the overlapping portion. If switching the abnormality data to be analyzed in the case of tracing back beyond the boundary between the non-overlapping portion and the overlapping portion, the abnormality diagnostic part 90 is not able to analyze continuous change in the degree of abnormality, and thus hardly discriminates whether or not the abnormal deterioration is present. As shown in FIG. 10, in the case where a range SEC1b, a range SEC2b and a range SEC3b are set without any overlapping portion therebetween, the abnormality diagnostic part 90, for example, in the case of tracing back beyond the boundary between the second range SEC2b and the first range SEC1b, needs to switch the abnormality data for analysis from the second abnormality data to the first abnormality data, and thus hardly discriminates whether or not the abnormal deterioration is present. In the present embodiment, the abnormality diagnostic part 90 discriminates whether or not the abnormal deterioration is present without switching the abnormality data for analysis, in the case of tracing back beyond the boundary relevant to the ranges of the travel distance, thereby enabling to appropriately discriminate whether or not the abnormal deterioration is present.

### B. Other Embodiments

B1:

In the first embodiment described above, in the abnormality diagnostic system 10, a travel distance of the fuel cell vehicle 100 is used as the index indicating the degree of deterioration of the fuel cell 110 subjected to the diagnosis. Alternatively, an integrated operating time of the first control unit 115 may be used as the index indicating the degree of deterioration of the fuel cell 110. In this case, during when the fuel cell vehicle 100 travels by the power supplied by the secondary battery 120 without the power supplied by the fuel cell 110, the integrated operating time of the first control unit 115 is not increased, and thus the degree of deterioration of the fuel cell 110 is able to be indicated more accurately. Therefore, an operator or the abnormality diagnostic part 90 is able to perform more accurate diagnosis.

B2:

In the first embodiment described above, in the abnormality diagnostic system 10, a travel distance of the fuel cell vehicle 100 is used as the index indicating the degree of deterioration of the fuel cell 110 subjected to diagnosis. Alternatively, an integrated power generation amount of the fuel cell 110 may be used as the index indicating the degree of deterioration of the fuel cell 110 subjected to the diagnosis. In this case, the degree of deterioration of the fuel cell 110 is increased in accordance with the balance between the amount of power supplied by the fuel cell 110 to the fuel cell vehicle 100 and the amount of power supplied by the secondary battery 120 to the fuel cell vehicle 100, and thus the degree of deterioration of the fuel cell 110 is able to be indicated more accurately. Therefore, an operator or the abnormality diagnostic part 90 is able to perform more accurate diagnosis.

B3:

In the first embodiment described above, the data recording apparatus 20 includes the three model generation parts 71 to 73, and the three abnormality data generation parts 81 to 83. Alternatively, the data recording apparatus 20 may include two, or four or a greater number of the model generation parts. The data recording apparatus 20 may include two, or four or a greater number of the abnormality data generation parts. In the data recording apparatus 20, one model generation part may generate the plurality of models MD1 to MD3, or one abnormality data generation part may generate abnormality data relevant to a plurality of ranges with various degrees of deterioration.

B4:

In the first embodiment described above, the first range SEC1 and the second range SEC2 are partially overlapped with each other, and the second range SEC2 and the third range SEC3 are partially overlapped with each other. Alternatively, the first range SEC1 and the second range SEC2 may be partially overlapped with each other, while the second range SEC2 and the third range SEC3 may never be overlapped with each other. Further alternatively, the second range SEC2 and the third range SEC3 may be partially overlapped with each other, while the first range SEC1 and the second range SEC2 may never be overlapped with each other.

B5:

In the first embodiment described above, in the configuration of the abnormality diagnostic system 10, the fuel cell vehicles 100A to 100E are connected to the data recording apparatus 20 in a unidirectional communication method. Alternatively, the fuel cell vehicles 100A to 100E may be connected to the data recording apparatus 20 in a bidirectional communication method. The data recording apparatus 20 may transmit the signal indicating that abnormal deterioration has been detected, to the fuel cell vehicle 100 equipped with the fuel cell 110 with the abnormal deterioration detected, and the fuel cell vehicle 100 having received the signal may turn on a warning light disposed on the instrument panel thereof. In this case, a driver or other person on the fuel cell vehicle 100 with the warning light turned on is able to request a dealer or the like to replace or repair the fuel cell 110, and thus the fuel cell 110 with the abnormal deterioration is able to be replaced or repaired in an early stage.

B6:

In the first embodiment described above, the data recording apparatus 20 includes the abnormality diagnostic part 90, and the abnormality diagnostic part 90 discriminates whether or not the abnormal deterioration is present. Alternatively, the data recording apparatus 20 may not include the abnormality diagnostic part 90. In this case, the data recording apparatus 20 may be connected to, for example, a computer for diagnosis, and an operator may discriminate whether or not the abnormal deterioration is present, by using the computer.

B7:

In the first embodiment described above, the data recording apparatus 20 calculates a prediction value of the output voltage of the fuel cell 110 by using the models MD1 to MD3, and calculates the degree of abnormality of the fuel cell 110 by using the calculated prediction value of the output voltage. Alternatively, the data recording apparatus 20 may calculate the degree of abnormality of the fuel cell 110, by using a model for calculating the degree of abnormality of the fuel cell 110.

B8:

In the first embodiment described above, the data recording apparatus 20 diagnoses abnormality of the fuel cell 110 mounted on the fuel cell vehicle 100. Alternatively, the data recording apparatus 20 may diagnose abnormality of other diagnostic targets.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) In one aspect of the present disclosure, a data recording apparatus is provided. The data recording apparatus includes a model storage configured to store a model generated by use of sample data indicating a sample measurement value obtained by measuring a sample and a degree of deterioration of the sample at the time when the sample measurement value is obtained, and a controller configured to acquire target data indicating a target measurement value obtained by measuring a target and a degree of deterioration of the target at the time when the target measurement value is obtained, and configured to generate abnormality data indicating change in a degree of abnormality of the target in accordance with the degree of deterioration, by use of the model and the target data. The model storage stores a first model generated by use of the sample data relevant to the degree of deterioration of the sample belonging to a first range, and a second model generated by use of the sample data relevant to the degree of deterioration of the sample belonging to a second range partially overlapping with the first range. The controller generates first abnormality data indicating change in a first abnormality of the target in accordance with the degree of deterioration in the first range, by using the target data relevant to the degree of deterioration of the target belonging to the first range, and the first model, and generates second abnormality data indicating change in a second abnormality of the target in accordance with the degree of deterioration in the second range, by using the target data relevant to the degree of deterioration of the target belonging to the second range, and the second model.

The data recording apparatus in the present aspect generates the first abnormality data indicating change in the abnormality in accordance with the degree of deterioration in the first range, and the second abnormality data indicating change in the abnormality in accordance with the degree of deterioration in the second range, and an operator is thus able to analyze continuous change in the abnormality in the first range by using the first abnormality data, and analyze continuous change in the abnormality in the second range by using the second abnormality data. Since the first range and the second range partially overlap with each other, in the case of analyzing continuous change in the abnormality in terms of the range including the first range and the second range, an operator is able to analyze continuous change in the abnormality in terms of at least a range of the length of the overlapping portion, by use of the first abnormality data or the second abnormality data. Accordingly, when diagnosing abnormality of the target, an operator is able to discriminate between abnormal deterioration and normal aged deterioration of the target.

(2) In the data recording apparatus in the aspect described above, the controller may calculate a first prediction value of predicting the target measurement value in the first range on the basis of the first model, and may calculate a difference between the first prediction value and the target measurement value indicated in the target data, as the first abnormality, and may further calculate a second prediction value of predicting the target measurement value in the second range on the basis of the second model, and may calculate a difference between the second prediction value and the target measurement value indicated in the target data, as the second abnormality.

The data recording apparatus in the present aspect is capable of reflecting the influence caused by the aged deterioration of the target, on the first prediction value obtained on the basis of the first model and the second prediction value obtained on the basis of the second model, without using the degree of deterioration for the input to the first model and the second model. This allows to reduce a calculation load in calculating the abnormality.

(3) The data recording apparatus in the aspect described above, in the case of abnormality diagnosis of the target by tracing back of the degree of deterioration from a non-overlapping portion of the second range exceeding the first range toward an overlapping portion of the second range overlapping with the first range, the controller may diagnose abnormality of the target by using the second abnormality data without switching from the second abnormality data to the first abnormality data, even beyond the boundary between the non-overlapping portion and the overlapping portion.

The data recording apparatus in the present aspect is capable of diagnosing abnormality of the target, by automatically discriminating between abnormal deterioration and general aged deterioration of the target, without operator's analysis of change in the abnormality of the target by use of the abnormality data.

(4) In the data recording apparatus in the aspect described above, the target may be a fuel cell mounted on a fuel cell vehicle.

The data recording apparatus in the present aspect is capable of generating abnormality data indicting change in the abnormality in accordance with the degree of deterioration of the fuel cell mounted on the fuel cell vehicle.

(5) In the data recording apparatus in the aspect described above, the degree of deterioration of the target may be indicated by an integrated travel distance of the fuel cell vehicle.

The data recording apparatus in the present aspect is capable of generating abnormality data indicating change in the abnormality of the fuel cell in accordance with the integrated travel distance of the fuel cell vehicle.

(6) In the data recording apparatus in the aspect described above, the fuel cell vehicle may include a secondary battery, a first control unit configured to control power generation of the fuel cell, and a second control unit configured to control power supply from the secondary battery. The degree of deterioration of the target may be indicated by an integrated operating time of the first control unit.

In the data recording apparatus in the present aspect, the degree of deterioration of the fuel cell is not increased, in the case where the fuel cell vehicle travels by the power supplied by the secondary battery without the power supplied by fuel cell. Accordingly, the degree of deterioration of the fuel cell is able to be indicated more accurately.

(7) In the data recording apparatus in the aspect described above, the fuel cell vehicle may include a secondary battery, and may travel by use of the power supplied by at least one of the fuel cell and the secondary battery. The degree of deterioration of the target may be indicated by an integrated power generation amount of the fuel cell.

In the data recording apparatus in the present aspect, the degree of deterioration of the fuel cell is increased in accordance with the balance between the amount of power supplied by the fuel cell to the fuel cell vehicle and the amount of power supplied by the secondary battery to the fuel cell vehicle. Accordingly, the degree of deterioration of the fuel cell is able to be indicated more accurately.

The present disclosure may be realized in various aspects other than the data recording apparatus. In an example, the present disclosure may be realized in a data recording method, an abnormality diagnostic apparatus and an abnormality diagnostic method.

What is claimed is:

1. A data recording apparatus comprising:
a model storage configured to store a model generated by use of sample data indicating a sample measurement value obtained by measuring a sample and a degree of deterioration of the sample at a time when the sample measurement value is obtained; and
a controller configured to acquire target data indicating a target measurement value obtained by measuring a target and a degree of deterioration of the target at a time when the target measurement value is obtained, and
configured to generate abnormality data indicating change in a degree of abnormality of the target in accordance with the degree of deterioration, by use of the model and the target data, wherein
the model storage stores a first model generated by use of the sample data relevant to the degree of deterioration of the sample belonging to a first range, and a second model generated by use of the sample data relevant to the degree of deterioration of the sample belonging to a second range partially overlapping with the first range, and
the controller generates first abnormality data indicating change in a first abnormality of the target in accordance with the degree of deterioration in the first range, by using the target data relevant to the degree of deterioration of the target belonging to the first range, and the first model, and
generates second abnormality data indicating change in a second abnormality of the target in accordance with the degree of deterioration in the second range, by using the target data relevant to the degree of deterioration of the target belonging to the second range, and the second model.

2. The data recording apparatus according to claim 1, wherein
the controller
calculates a first prediction value of predicting the target measurement value in the first range on a basis of the first model, and calculates a difference between the first prediction value and the target measurement value indicated in the target data, as the first abnormality, and
calculates a second prediction value of predicting the target measurement value in the second range on a basis of the second model, and calculates a difference between the second prediction value and the target measurement value indicated in the target data, as the second abnormality.

3. The data recording apparatus according to claim 1, wherein
in a case of abnormality diagnosis of the target by tracing back of the degree of deterioration from a non-overlapping portion of the second range exceeding the first range toward an overlapping portion of the second range overlapping with the first range, the controller diagnoses abnormality of the target by using the second abnormality data without switching from the second abnormality data to the first abnormality data, even beyond a boundary between the non-overlapping portion and the overlapping portion.

4. The data recording apparatus according to claim 1, wherein
the target is a fuel cell mounted on a fuel cell vehicle.

5. The data recording apparatus according to claim 4, wherein
the degree of deterioration of the target is indicated by an integrated travel distance of the fuel cell vehicle.

6. The data recording apparatus according to claim 4, wherein
the fuel cell vehicle includes a secondary battery, a first control unit configured to control power generation of the fuel cell, and a second control unit configured to control power supply from the secondary battery, and
the degree of deterioration of the target is indicated by an integrated operating time of the first control unit.

7. The data recording apparatus according to claim 4, wherein
the fuel cell vehicle includes a secondary battery, and travels by use of power supplied by at least one of the fuel cell and the secondary battery, and
the degree of deterioration of the target is indicated by an integrated power generation amount of the fuel cell.

8. A data recording method comprising:
storing a model generated by use of sample data indicating a sample measurement value obtained by measuring a sample and a degree of deterioration of the sample at a time when the sample measurement value is obtained;
acquiring target data indicating a target measurement value obtained by measuring a target and a degree of deterioration of the target at a time when the target measurement value is obtained; and
generating abnormality data indicating change in a degree of abnormality of the target in accordance with the degree of deterioration, by using the model and the target data, wherein
the storing stores a first model generated by use of the sample data relevant to the degree of deterioration of the sample belonging to a first range, and a second model generated by use of the sample data relevant to the degree of deterioration of the sample belonging to a second range partially overlapping with the first range, and
the generating generates first abnormality data indicating change in a first abnormality of the target in accordance with the degree of deterioration in the first range, by use of the target data relevant to the degree of deterioration of the target belonging to the first range, and the first model, and
to generate second abnormality data indicating change in a second abnormality of the target in accordance with the degree of deterioration in the second range, by use of the target data relevant to the degree of deterioration of the target belonging to the second range, and the second model.

9. The data recording method according to claim 8, wherein
the generating
calculates a first prediction value of predicting the target measurement value in the first range on a basis of the first model, and calculates a difference between the first prediction value and the target measurement value indicated in the target data, as the first abnormality, and
calculates a second prediction value of predicting the target measurement value in the second range on a basis of the second model, and calculates a difference between the second prediction value and the target measurement value indicated in the target data, as the second abnormality.

10. The data recording method according to claim 8, data recording method further comprising:
diagnosing abnormality of the target by use of the first abnormality data and the second abnormality data, wherein
in a case of abnormality diagnosis of the target by tracing back of the degree of deterioration from a non-overlapping portion of the second range exceeding the first range toward an overlapping portion of the second range overlapping with the first range, the diagnosing diagnoses abnormality of the target by using the second abnormality data without switching from the second abnormality data to the first abnormality data, even beyond a boundary between the non-overlapping portion and the overlapping portion.

11. The data recording method according to claim 8, wherein
the target is a fuel cell mounted on a fuel cell vehicle.

12. The data recording method according to claim 11, wherein
the degree of deterioration of the target is indicated by an integrated travel distance of the fuel cell vehicle.

13. The data recording method according to claim 11, wherein
the fuel cell vehicle includes a secondary battery, a first control unit configured to control power generation of the fuel cell, and a second control unit configured to control power supply from the secondary battery, and
the degree of deterioration of the target is indicated by an integrated operating time of the first control unit.

14. The data recording method according to claim 11, wherein
the fuel cell vehicle includes a secondary battery, and travels by use of power supplied by at least one of the fuel cell and the secondary battery, and
the degree of deterioration of the target is indicated by an integrated power generation amount of the fuel cell.
